(19) United States
(12) Patent Application Publication
(10) Pub. No.: US 2025/0319497 A1
(43) Pub. Date: Oct. 16, 2025

(54) OPTICAL-CONNECTOR CLEANER AND METHOD OF CLEANING END SURFACE OF OPTICAL CONNECTOR

(71) Applicant: SUMITOMO ELECTRIC INDUSTRIES, LTD., Osaka-shi (JP)

(72) Inventor: Yoshihiro TAKEYAMA, Osaka-shi (JP)

(73) Assignee: SUMITOMO ELECTRIC INDUSTRIES, LTD., Osaka-shi (JP)

(21) Appl. No.: 19/085,471

(22) Filed: Mar. 20, 2025

(30) Foreign Application Priority Data
Apr. 16, 2024 (JP) 2024-066072

(51) Int. Cl. B08B 1/14; B08B 1/30; G02B 6/38

(52) U.S. Cl. CPC B08B 1/143; B08B 1/30; G02B 6/3866; B08B 2240/02

(57) ABSTRACT

An optical-connector cleaner includes a pad having a first surface and having elasticity in at least the first surface, and a cleaning cloth disposed on or above the first surface of the pad and extending in a first direction. The pad has a first cut formed in the first surface and extending in the first direction, and a second cut formed in the first surface and extending in the first direction such that the first cut and the second cut are arranged side by side. At least a portion of the cleaning cloth in the first direction is divided by a first dividing line and a second dividing line, the first dividing line overlapping the first cut, the second dividing line overlapping the second cut.

### CROSS REFERENCE TO RELATED APPLICATIONS

This application claims priority based on Japanese Patent Application No. 2024-066072 filed on Apr. 16, 2024, and the entire contents of the Japanese patent application are incorporated herein by reference.

### TECHNICAL FIELD

The present disclosure relates to an optical-connector cleaner and a method of cleaning an end surface of an optical connector.

### BACKGROUND

Patent literature 1 and patent literature 2 disclose an optical connector cleaning tool. In the optical connector cleaning tool of patent literature 1, by pressing a lever, a tape running mechanism is operated to wind up a cleaning sheet tape, and the unused and unsoiled cleaning sheet tape appears in a cleaning window. The end surface of an optical connector is rubbed with the cleaning sheet tape placed on an elasticity pad, and thus the dirt on the end surface of the optical connector is wiped off. In the optical connector cleaning tool of patent literature 2, a base made of an elastic or non-elastic body is provided under a cleaning sheet. The base has a long hole formed therein through which a mating pin is inserted. The long hole may be either a through hole or a non-through hole. To facilitate relative movement between the cleaning sheet and the optical connector, the width of the long hole is larger than the outer diameter of the mating pin.
Patent literature 1: Japanese Unexamined Patent Application Publication No. 2003-290722
Patent literature 2: Japanese Unexamined Patent Application Publication No. 2002-156552
Patent literature 3: Japanese Unexamined Patent Application Publication No. 2003-185883

### SUMMARY

An optical-connector cleaner according to an embodiment of the present disclosure includes a pad having a first surface and having elasticity in at least the first surface, and a cleaning cloth disposed on or above the first surface of the pad and extending in a first direction. The pad has a first cut formed in the first surface and extending in the first direction, and a second cut formed in the first surface and extending in the first direction such that the first cut and the second cut are arranged side by side. At least a portion of the cleaning cloth in the first direction is divided by a first dividing line and a second dividing line, the first dividing line overlapping the first cut, the second dividing line overlapping the second cut.

### BRIEF DESCRIPTION OF THE DRAWINGS

FIG. 1 is a perspective view showing an optical-connector cleaner according to an embodiment of the present disclosure.

FIG. 2 is a diagram showing a cross-section of an optical-connector cleaner perpendicular to a first direction.

FIG. 3A is a diagram showing how a film is fixed to a cleaning cloth.

FIG. 3B is a diagram showing how a film is fixed to a cleaning cloth.

FIG. 3C is a diagram showing how a film is fixed to a cleaning cloth.

FIG. 4A is a diagram showing a step of cleaning an end surface of a ferrule by rubbing the end surface of the ferrule with a cleaning cloth.

FIG. 4B is a diagram showing a step of cleaning an end surface of a ferrule by rubbing the end surface of the ferrule with a cleaning cloth.

FIG. 5A is a schematic diagram showing a configuration described in patent literature 2.

FIG. 5B is a schematic diagram showing a configuration described in patent literature 2.

FIG. 5C is a schematic diagram showing a configuration described in patent literature 2.

FIG. 6 is a diagram for explaining a problem in a case where a film is not provided.

### DETAILED DESCRIPTION

An MPO type optical connector has a ferrule that holds the end portion of a plurality of optical fibers. The end faces of the plurality of optical fibers are exposed from the end surface of the ferrule. The end surfaces of the ferrules of the two optical connectors are pressed against each other to connect the optical fibers to each other. Two guide pins protrude from the end surface of the ferrule of one optical connector of the two optical connectors. The two guide pins are provided at positions sandwiching the end faces of the plurality of optical fibers. Two guide pin holes into which the two guide pins are respectively inserted are formed in the end surface of the ferrule of the other optical connector of the two optical connectors. When two optical connectors are connected to each other, the ferrules are positioned with respect to each other by inserting the two guide pins into the two guide pin holes.

When cleaning the end surface of an optical connector, a cleaning cloth (cleaning sheet) disposed on an elasticity pad is pressed against the end surface of the optical connector, and the end surface of the optical connector is rubbed with the cleaning cloth. At this time, the presence of the guide pin on the optical connector becomes a problem. When the elasticity pad is made convex so as to avoid the guide pin, the cleaning cloth is not in contact with the area around the guide pin and outside the guide pin, and the areas is left unwiped. Furthermore, in the case where a long hole as described in patent literature 2 is provided in a base, when cleaning the end surface of the ferrule of the optical connector in which a guide pin is not provided, the cleaning cloth is not supported by the elasticity pad over the long hole, and the cleaning cloth cannot be pressed against the end surface of the ferrule. As a result, areas of the ferrule end surface around the guide pin hole will be left unwiped.

The present disclosure aims to provide an optical-connector cleaner that reduces unwiped area around guide pin holes and a method of cleaning an end surface of an optical connector.

### EMBODIMENTS OF PRESENT DISCLOSURE

First, the contents of the embodiments of the present disclosure will be listed and explained.

[1] An optical-connector cleaner according to an embodiment of the present disclosure includes a pad having a first surface and having elasticity in at least the first surface, and a cleaning cloth disposed on or above the first surface of the pad and extending in a first direction. The pad has a first cut formed in the first surface and extending in the first direction, and a second cut formed in the first surface and extending in the first direction such that the first cut and the second cut are arranged side by side. At least a portion of the cleaning cloth in the first direction is divided by a first dividing line and a second dividing line, the first dividing line overlapping the first cut, the second dividing line overlapping the second cut.

When the end surface of the ferrule of an optical connector is cleaned by rubbing the end surface with a cleaning cloth using the optical-connector cleaner of the above [1], in the case where the optical connector includes a first guide pin and a second guide pin that protrude from the end surface, the end surface can be rubbed while the first guide pin is inserted into the first cut through the first dividing line and the second guide pin is inserted into the second cut through the second dividing line. At this time, since the pad has elasticity in at least the first surface, the first guide pin and the second guide pin can push open the first cut and the second cut, respectively. Thus, regardless of the presence of the first guide pin and the second guide pin, the entire end surface of the ferrule can be rubbed with a cleaning cloth. Also, when the optical connector does not include the first guide pin and the second guide pin, the first cut and the second cut are closed by the elasticity of the pad, and thus the cleaning cloth is supported by the pad even on the first cut and the second cut, and the cleaning cloth is pressed against the end surface of the ferrule. Thus, it is possible to reduce unwiped area around the guide pin hole on the end surface of the ferrule.

[2] In the optical-connector cleaner of the above [1], the first cut and the second cut may have no space. In such a case, for example, it is possible to reduce the unwiped area around the guide pin hole on the end surface of the ferrule.

[3] In the optical-connector cleaner of the above [1], a width of a space of the first cut and a width of a space of the second cut in a cross-section perpendicular to the first direction may be each smaller than a diameter of a guide pin of an optical connector. Even in such a case, it is possible to reduce the unwiped area around the guide pin hole on the end surface of the ferrule.

[4] The optical-connector cleaner of the above [1] to [3] may further include a film disposed between the first surface of the pad and the cleaning cloth and fixed to the cleaning cloth. The film may have a plurality of first slits and a plurality of second slits. The plurality of first slits may be provided intermittently in the first direction, and each of the plurality of first slits may extend in the first direction while overlapping the first dividing line. The plurality of second slits may be provided intermittently in the first direction, and each of the plurality of second slits may extend in the first direction while overlapping the second dividing line. Since the optical-connector cleaner includes such a film, the divided parts of the cleaning cloth are fixed to each other by the film, and thus it is possible to avoid the overlapping or entanglement of the divided parts.

[5]A method of cleaning an end surface of an optical connector according to an embodiment of the present disclosure includes disposing, with respect to a pad having a first surface and having elasticity in at least the first surface, a cleaning cloth on or above the first surface, the cleaning cloth extending in a first direction; and cleaning an end surface of a ferrule of an optical connector by rubbing the end surface with the cleaning cloth. The first surface of the pad has a first cut extending in the first direction and a second cut extending in the first direction such that the first cut and the second cut are arranged side by side. At least a portion of the cleaning cloth in the first direction is divided by a first dividing line and a second dividing line, the first dividing line overlapping the first cut, the second dividing line overlapping the second cut. When the optical connector includes a first guide pin and a second guide pin that protrude from the end surface, the end surface is rubbed in the cleaning while the first guide pin is inserted into the first cut through the first dividing line and the second guide pin is inserted into the second cut through the second dividing line.

When the optical connector includes the first guide pin and the second guide pin that protrude from the end surface, the end surface is rubbed in the cleaning method of the above [5] while the first guide pin being inserted into the first cut through the first dividing line and the second guide pin being inserted into the second cut through the second dividing line. At this time, since the pad has elasticity in at least the first surface, the first guide pin and the second guide pin can push open the first cut and the second cut, respectively. Thus, regardless of the presence of the first guide pin and the second guide pin, the entire end surface of the ferrule can be rubbed with the cleaning cloth. Also, when the optical connector does not include the first guide pin and the second guide pin, the first cut and the second cut are closed by the elasticity of the pad, and thus the cleaning cloth is supported by the pad even on the first cut and the second cut, and the cleaning cloth is pressed against the end surface of the ferrule. Thus, it is possible to reduce unwiped area around the guide pin hole on the end surface of the ferrule.

### DETAILS OF EMBODIMENTS OF PRESENT DISCLOSURE

Specific examples of the present disclosure will be described below with reference to the drawings. The present disclosure is not limited to the examples, but is defined by the scope of the claims, and is intended to include all modifications within the meaning and scope equivalent to the scope of the claims. In the following description, the same elements are denoted by the same reference numerals in the description of the drawings, and redundant description will be omitted.

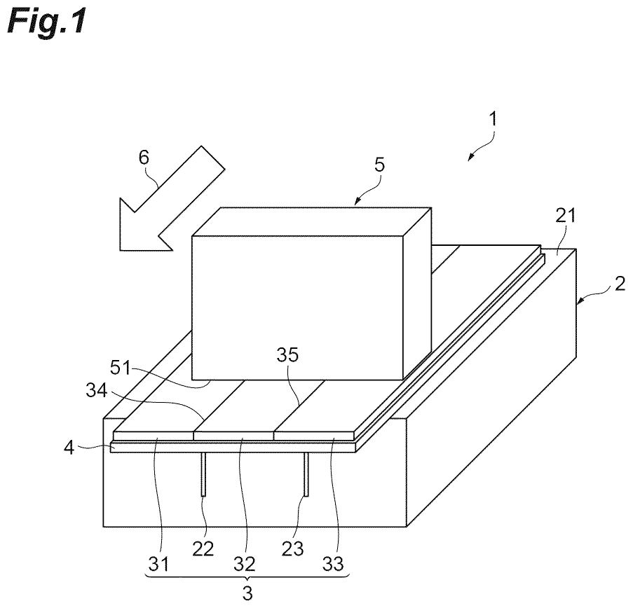

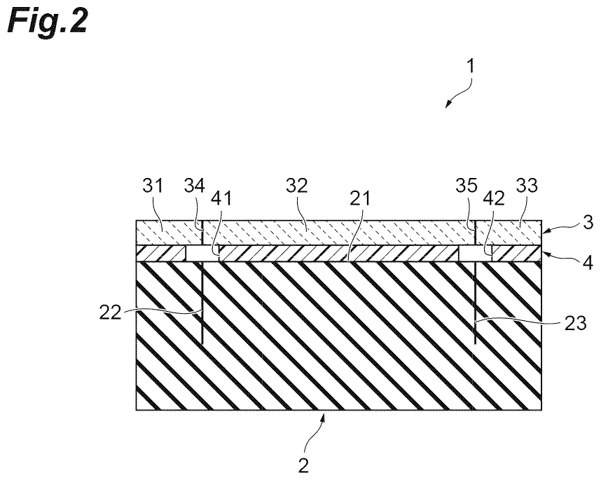

FIG. 1 is a perspective view showing an optical-connector cleaner 1 according to an embodiment of the present disclosure. FIG. 2 is a diagram showing a cross-section of optical-connector cleaner 1 perpendicular to a first direction 6. Optical-connector cleaner 1 is a tool for cleaning an end surface 51 of a ferrule 5 of an optical connector. The optical connector is, for example, an MPO type optical connector, and ferrule 5 is, for example, an MT ferrule. Optical-connector cleaner 1 includes a pad 2, a cleaning cloth 3, and a film 4.

Pad 2 has a first surface 21 which is flat. Pad 2 has elasticity in at least first surface 21. First surface 21 of pad 2 is made of a soft material, such as urethane rubber or silicone rubber. Pad 2 has a first cut 22 and a second cut 23. First cut 22 is formed in first surface 21 and extends in first direction 6. Second cut 23 is formed in first surface 21 and extends in first direction 6 such that first cut 22 and second cut 23 are arranged side by side. The lateral width of first cut 22 and second cut 23 in a plane perpendicular to first direction 6 is substantially zero. In other words, first cut 22 and second cut 23 have no space. The depth of first cut 22 and second cut 23 along the normal direction of first surface 21 is, for example, within the range of 2 mm to 10 mm.

Cleaning cloth 3 is disposed on or above first surface 21 of pad 2. Cleaning cloth 3 is made of a material such as polyamide resin or PET resin. Cleaning cloth 3 extends along first direction 6. Cleaning cloth 3 is sequentially fed out in first direction 6 by a running mechanism (not shown) from a state of being wound around a reel, and moves along first direction 6 on first surface 21 of pad 2. At least a portion of cleaning cloth 3 in first direction 6 is divided by a first dividing line 34 and a second dividing line 35, and thus cleaning cloth 3 includes three parts 31, 32 and 33. First dividing line 34 and second dividing line 35 extend along first direction 6 and are parallel to each other. First dividing line 34 is located at a position overlapping with first cut 22 when viewed from the normal direction of first surface 21. Second dividing line 35 is located at a position overlapping with second cut 23 when viewed from the normal direction of first surface 21.

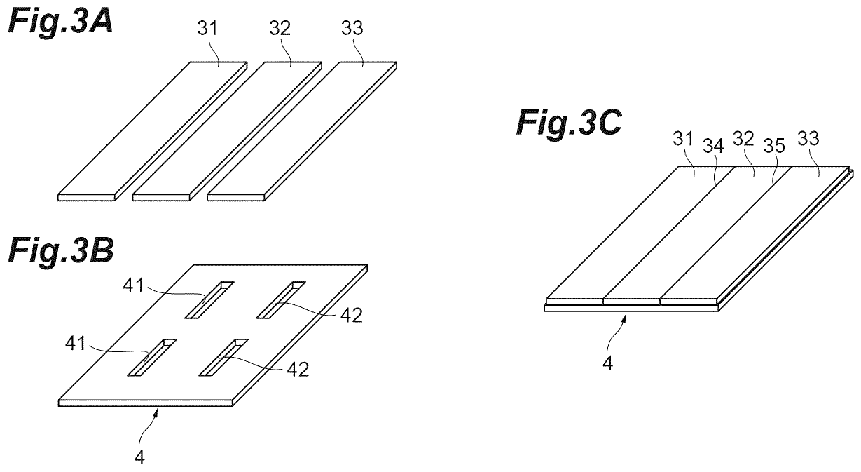

Film 4 is disposed between first surface 21 of pad 2 and cleaning cloth 3. Film 4 is made of, for example, polyethylene or polypropylene. Film 4 is closely attached and fixed to cleaning cloth 3, and is integrated with cleaning cloth 3. FIGS. 3A to 3C are diagrams showing how film 4 is fixed to cleaning cloth 3. As described above, cleaning cloth 3 includes three parts 31, 32 and 33 extending along first direction 6 (see FIG. 3A). These three parts 31, 32 and 33 are separated from each other. Also, as shown in FIG. 3B, film 4 has a plurality of first slits 41 and a plurality of second slits 42. The plurality of first slits 41 are provided intermittently in first direction 6. Each of the plurality of first slits 41 extends in first direction 6. The plurality of second slits 42 are provided intermittently in first direction 6. Each of the plurality of second slits 42 extends in first direction 6.

As shown in FIG. 3C, cleaning cloth 3 and film 4 having the above-described configuration are overlapped on each other, and film 4 is adhered to cleaning cloth 3. At this time, each of the plurality of first slits 41 is overlapped with first dividing line 34 which is the boundary between part 31 and part 32. Also, each of the plurality of second slits 42 is overlapped with second dividing line 35 which is the boundary between part 32 and part 33. As a result, as shown in FIG. 2, when viewed from the normal direction of first surface 21, the plurality of first slits 41 overlap with first cut 22, and the plurality of second slits 42 overlap with second cut 23.

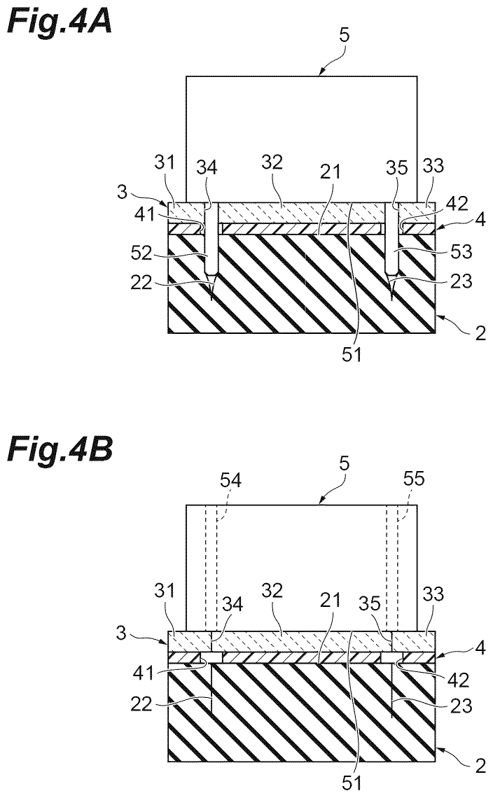

The method of cleaning an end surface of the embodiment is performed by using, for example, optical-connector cleaner 1. The method ofusing optical-connector cleaner 1 will be described below, together with the method of cleaning an end surface of the embodiment. This method of cleaning an end surface includes disposing cleaning cloth 3 on or above first surface 21 of pad 2 (see FIG. 2), and cleaning end surface 51 of ferrule 5 by rubbing end surface 51 with cleaning cloth 3 (see FIGS. 4A and 4B). When ferrule 5 includes a first guide pin 52 and a second guide pin 53 that protrude from end surface 51, in the cleaning, as shown in FIG. 4A, ferrule 5 is pressed against cleaning cloth 3 and is moved along first direction 6 while first guide pin 52 being inserted into first cut 22 through first dividing line 34, and second guide pin 53 being inserted into second cut 23 through second dividing line 35, so that end surface 51 is rubbed with cleaning cloth 3. Thus, the width of each first slit 41 in the direction perpendicular to first direction 6 is larger than the diameter of first guide pin 52. Also, the width of each second slit 42 in the direction perpendicular to first direction 6 is larger than the diameter of second guide pin 53.

In addition, when ferrule 5 does not include first guide pin 52 and second guide pin 53 that protrude from end surface 51, in other words, when ferrule 5 has a first guide pin hole 54 and a second guide pin hole 55 into which first guide pin 52 and second guide pin 53 are inserted, then in the cleaning, as shown in FIG. 4B, ferrule 5 is pressed against cleaning cloth 3 and is moved along first direction 6, so that end surface 51 is rubbed with cleaning cloth 3.

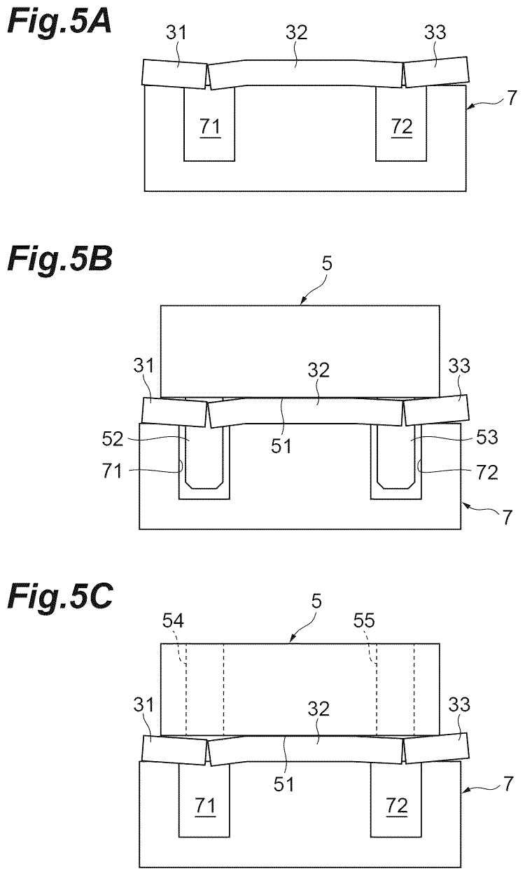

The effects obtained by optical-connector cleaner 1 and the method of cleaning an end surface of the embodiment described above will be explained together with the problems with the conventional technology. FIGS. 5A and 5B are schematic diagrams showing the configuration described in patent literature 2. As shown in the figures, long holes 71 and 72 into which first guide pin 52 and second guide pin 53 are respectively inserted are formed in a base 7. Parts 31, 32 and 33 of cleaning cloth 3 are disposed on this base 7. To facilitate the relative movement between cleaning cloth 3 and ferrule 5, the widths of long holes 71 and 72 are formed to be larger than the outer diameters of first guide pin 52 and second guide pin 53.

However, as shown in FIG. 5C, when end surface 51 of ferrule 5 of the optical connector that does not have first guide pin 52 and second guide pin 53 (i.e. ferrule 5 having first guide pin hole 54 and second guide pin hole 55) is cleaned, cleaning cloth 3 is not supported by base 7 over long holes 71 and 72, and cleaning cloth 3 is not pressed against end surface 51 of ferrule 5. As a result, areas remain unwiped around first guide pin hole 54 and second guide pin hole 55 of end surface 51 of ferrule 5. Also, if base 7 without long holes 71 and 72 is used when ferrule 5 does not have first guide pin 52 and second guide pin 53, it is necessary to use two types of base 7 depending on whether first guide pin 52 and second guide pin 53 are present, and it becomes complicated to distinguish between two types of bases 7.

When end surface 51 of ferrule 5 is cleaned by rubbing end surface 51 with cleaning cloth 3 using optical-connector cleaner 1 in the embodiment, in the case where ferrule 5 includes first guide pin 52 and second guide pin 53, end surface 51 is rubbed while first guide pin 52 being inserted into first cut 22 through first dividing line 34, and second guide pin 53 being inserted into second cut 23 through second dividing line 35. At this time, since pad 2 has elasticity in at least first surface 21, first guide pin 52 and second guide pin 53 can push open first cut 22 and second cut 23, respectively. Thus, regardless of the presence of first guide pin 52 and second guide pin 53, the entire end surface 51 of ferrule 5 can be rubbed with cleaning cloth 3. Also, when the optical connector does not include first guide pin 52 and second guide pin 53 (when ferrule 5 includes first guide pin hole 54 and second guide pin hole 55), first cut 22 and second cut 23 are closed by the elasticity of pad 2, and thus that cleaning cloth 3 is supported by pad 2 even on first cut 22 and second cut 23, and cleaning cloth 3 is pressed against end surface 51 of ferrule 5. Thus, according to the embodiment, it is possible to reduce the unwiped area around first guide pin hole 54 and second guide pin hole 55 of end surface 51 of ferrule 5. Thus, according to the embodiment, it is possible to provide an optical-connector cleaner that can sufficiently clean end surface 51 of ferrule 5 regardless of the presence or absence of first guide pin 52 and second guide pin 53 of ferrule 5, and thus there is no need to use two types of pads.

As described above, first cut 22 and second cut 23 may have no space. For example, in such a case, it is possible to reduce the unwiped areas around first guide pin hole 54 and second guide pin hole 55 of end surface 51 of ferrule 5.

As in the embodiment, film 4 may be disposed between first surface 21 of pad 2 and cleaning cloth 3, and fixed to cleaning cloth 3. Film 4 may have the plurality of first slits 41 and the plurality of second slits 42. The plurality of first slits 41 may be provided intermittently in first direction 6, and each of the plurality of first slits 41 may extend in first direction 6 while overlapping with first dividing line 34. The plurality of second slits 42 may be provided intermittently in first direction 6, and each of the plurality of second slits 42 may extend in first direction 6 while overlapping with second dividing line 35.

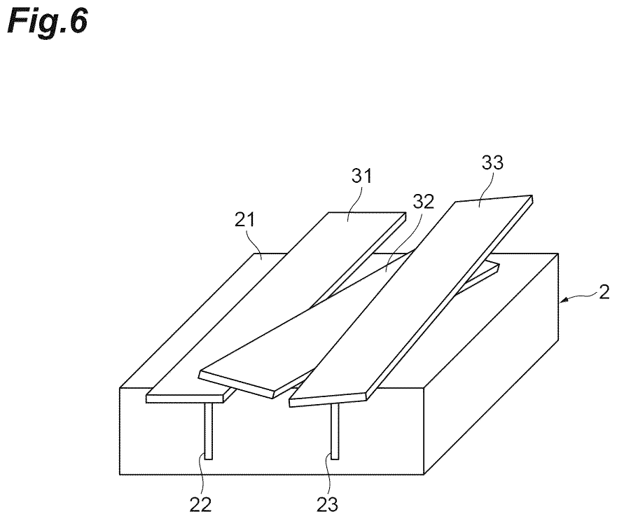

FIG. 6 is a diagram for explaining the problems in a case where such film 4 is not provided. Cleaning cloth 3 is made of a flexible material so that it can be stored in a wound state and can be fed out by a running mechanism. Thus, when film 4 is not provided, parts 31, 32, and 33 that are separated from each other are likely to be biased, or parts 31, 32, and 33 are likely to overlap or be entangled. When the positions of first dividing line 34 and second dividing line 35 of cleaning cloth 3 are shifted from the positions of first cut 22 and second cut 23 respectively due to the bias of parts 31, 32, and 33, first guide pin 52 and second guide pin 53 cannot be inserted into first cut 22 and second cut 23 respectively during cleaning. Thus, cleaning work cannot be performed smoothly. Optical-connector cleaner 1 includes film 4, and thus parts 31, 32, and 33 of cleaning cloth 3 are fixed together by film 4. Thus, it is possible to prevent parts 31, 32, and 33 from being biased, and from overlapping and being entangled with each other, and the cleaning work can be performed smoothly.

When ferrule 5 includes first guide pin 52 and second guide pin 53 that protrude from end surface 51, end surface 51 is rubbed in the cleaning method of the embodiment while first guide pin 52 being inserted into first cut 22 through first dividing line 34, and second guide pin 53 being inserted into second cut 23 through second dividing line 35. At this time, since pad 2 has elasticity in at least first surface 21, first guide pin 52 and second guide pin 53 can push open first cut 22 and second cut 23, respectively. Thus, regardless of the presence of first guide pin 52 and second guide pin 53, the entire end surface 51 of ferrule 5 can be rubbed with cleaning cloth 3. Also, when ferrule 5 does not include first guide pin 52 and second guide pin 53, first cut 22 and second cut 23 are closed by the elasticity of pad 2, and thus cleaning cloth 3 is supported by pad 2 even on first cut 22 and second cut 23, and cleaning cloth 3 is pressed against end surface 51 of ferrule 5. Thus, it is possible to reduce the unwiped area around first guide pin hole 54 and second guide pin hole 55 of end surface 51 of ferrule 5.

The optical-connector cleaner and the cleaning method of the end surface of an optical connector according to the present disclosure are not limited to the above-mentioned embodiment, and various other modifications are possible. For example, in the embodiment, film 4 is disposed between pad 2 and cleaning cloth 3, and parts 31, 32, and 33 of cleaning cloth 3 are fixed to each other by film 4. However, for example, when first dividing line 34 and second dividing line 35 of cleaning cloth 3 are formed intermittently and parts 31, 32, and 33 are less likely to overlap or be tangled with each other, film 4 may be omitted.

In the above embodiment, first cut 22 and second cut 23 have no space, and the lateral width of first cut 22 and second cut 23 is substantially zero. First cut 22 and second cut 23 are not limited to this, and may have space. In that case, the width of the space of first cut 22 and the width of the space of second cut 23 in the cross-section perpendicular to first direction 6 are each formed smaller than the diameter of first guide pin 52 and second guide pin 53 of ferrule 5. Even in such a case, it is possible to reduce the unwiped area around first guide pin hole 54 and second guide pin hole 55 of end surface 51 of ferrule 5.

What is claimed is:

1. An optical-connector cleaner comprising:
a pad having a first surface and having elasticity in at least the first surface; and
a cleaning cloth disposed on or above the first surface of the pad and extending in a first direction,
wherein the pad has
a first cut formed in the first surface and extending in the first direction, and
a second cut formed in the first surface and extending in the first direction such that the first cut and the second cut are arranged side by side, and
wherein at least a portion of the cleaning cloth in the first direction is divided by a first dividing line and a second dividing line, the first dividing line overlapping the first cut, the second dividing line overlapping the second cut.

2. The optical-connector cleaner according to claim 1,
wherein the first cut and the second cut have no space.

3. The optical-connector cleaner according to claim 1,
wherein a width of a space of the first cut and a width of a space of the second cut in a cross-section perpendicular to the first direction are each smaller than a diameter of a guide pin of an optical connector.

4. The optical-connector cleaner according to claim 1, further comprising:
a film disposed between the first surface of the pad and the cleaning cloth and fixed to the cleaning cloth,
wherein the film has a plurality of first slits and a plurality of second slits,
wherein the plurality of first slits are provided intermittently in the first direction, and each of the plurality of first slits extends in the first direction while overlapping the first dividing line, and
wherein the plurality of second slits are provided intermittently in the first direction, and each of the plurality of second slits extends in the first direction while overlapping the second dividing line.

5. A method of cleaning an end surface of an optical connector, the method comprising:
disposing, with respect to a pad having a first surface and having elasticity in at least the first surface, a cleaning cloth on or above the first surface, the cleaning cloth extending in a first direction; and
cleaning an end surface of a ferrule of an optical connector by rubbing the end surface with the cleaning cloth,
wherein the first surface of the pad has a first cut extending in the first direction and a second cut extending in the first direction such that the first cut and the second cut are arranged side by side,
wherein at least a portion of the cleaning cloth in the first direction is divided by a first dividing line and a second dividing line, the first dividing line overlapping the first cut, the second dividing line overlapping the second cut, and
wherein, when the optical connector includes a first guide pin and a second guide pin that protrude from the end surface, the end surface is rubbed in the cleaning while the first guide pin is inserted into the first cut through the first dividing line and the second guide pin is inserted into the second cut through the second dividing line.
